(19) United States
(12) Patent Application Publication
(10) Pub. No.: US 2002/0064638 A1
(43) Pub. Date: May 30, 2002

(54) Surface-modified nickel fine powder

(75) Inventors: Takayuki Araki, Yamaguchi (JP); Yoshiharu Toshima, Yamaguchi (JP)

Correspondence Address: YOUNG & THOMPSON, 745 SOUTH 23RD STREET 2ND FLOOR, ARLINGTON, VA, 22202

(73) Assignee: Mitsui Mining and Smelting Co., Ltd.

(21) Appl. No.: 10/022,541

(22) Filed: Dec. 20, 2001

Related U.S. Application Data
(63) Continuation of application No. 09/585,269, filed on Jun. 2, 2000.

(30) Foreign Application Priority Data
Jun. 3, 1999 (JP) 11-156737

(51) Int. Cl. H01M 6/00; H01M 10/00; B32B 3/00; B32B 5/16; B32B 7/00

(52) U.S. Cl. 428/206; 429/122

(57) ABSTRACT

Surface-modified nickel fine powder herein disclosed is characterized in that the surface of metal nickel fine particles is modified with a phosphate compound, a phosphite compound or a hypophosphite compound. The surface-modified nickel fine powder has a sharp heat shrinkage-initiating temperature shifted to not less than 900° C., can thus be quite suitable for use in the manufacture of an internal electrode for multi-layered capacitors and can accordingly inhibit any generation of delamination and crack-formation during the production of a high capacitance multi-layered ceramic capacitor.

### BACKGROUND OF THE INVENTION

(a) Field of the Invention

The present invention relates to nickel fine powder having a controlled rate of heat shrinkage and more specifically to surface-modified nickel fine powder, which has characteristic properties suitable for use as an internal electrode material for multi-layered ceramic capacitors, which is excellent, in particular, in resistance to heat shrinkage and which can therefore inhibit the generation of any delamination and cracks in the manufacture of high capacitance multi-layered ceramic capacitors.

(b) Description of the Prior Art

In the production of an internal electrode for multi-layered ceramic capacitors, it has been common that metal fine powder as an internal electrode material is formed into a paste, followed by printing a ceramic substrate using the paste, then unifying a plurality of the printed substrates by putting them in layers and pressure-attaching them with heating, and heating and firing the united laminate in a reducing atmosphere. As such an internal electrode material, there have conventionally been used, for instance, platinum and palladium, but there have recently been developed techniques, which make use of a base metal such as nickel in place of these platinum and palladium and they have still been advanced.

However, metal nickel fine powder has such a tendency that the powder causes sharp heat shrinkage at a temperature considerably lower than the foregoing temperature for firing and heating. Therefore, when metal nickel fine powder is used as an internal electrode material, the resulting multi-layered ceramic capacitor is susceptible to cause defects such as delamination and cracks upon firing due to the difference in resistance to heat shrinkage between the ceramic substrate and the metal nickel fine powder and this has been a serious problem to be solved.

The firing temperature used in the production of a multi-layered ceramic capacitor may vary depending on the constituents of the ceramic dielectric material. For instance, the temperature in general falls within the range of from about 1000 to 1400° C. for barium titanate ceramic dielectric material. Therefore, it is desirable that the sharp heat shrinkage-initiating temperature of the metal nickel fine powder be shifted to the higher temperature side to lower the rate of heat shrinkage thereof and to thus bring the heat shrinkage curve of the nickel fine powder for the paste used in the production of the multi-layered ceramic capacitor closer to the heat shrinkage curve of the ceramic substrate, in order to inhibit the generation of any delamination and crack upon firing the same.

### SUMMARY OF THE INVENTION

Accordingly, it is an object of the present invention to provide surface-modified nickel fine powder, which has characteristic properties suitable for use as an internal electrode material for multi-layered ceramic capacitors, which is excellent, in particular, in resistance to heat shrinkage, which has resistance to heat shrinkage close to those of ceramic substrates and which can therefore inhibit the generation of any delamination and cracks in the manufacture of high capacitance multi-layered ceramic capacitors.

The inventors of this invention have conducted various studies to achieve the foregoing object, have found that surface-modified nickel fine powder possessing the foregoing characteristic properties can be produced by modifying the surface of metal nickel fine powder with a specific compound and have thus completed the present invention based on the finding.

According to the present invention, the foregoing object can be accomplished by providing surface-modified nickel fine powder wherein the surface of the fine powder is modified with a phosphate compound, a phosphite compound or a hypophosphite compound.

### DETAILED DESCRIPTION OF THE INVENTION

In the surface-modified nickel fine powder of the present invention, the surface thereof is modified with a phosphate compound, a phosphite compound or a hypophosphite compound. Therefore, the surface-modified nickel fine powder of the invention has characteristic properties suitable for use as an internal electrode material for multi-layered ceramic capacitors, is excellent, in particular, in resistance to heat shrinkage, has resistance to heat shrinkage close to those of ceramic substrates and can therefore inhibit the generation of any delamination and cracks in the manufacture of high capacitance multi-layered ceramic capacitors.

In the present invention, any phosphate compound, phosphite compound and hypophosphite compound may be used in the modification of the surface thereof. Examples of phosphate, phosphite or hypophosphite compounds preferably used in the present invention are phosphoric acid, phosphoric acid esters, phosphoric acid salts, phosphorous acid, phosphorous acid salts, phosphorous acid esters, hypophosphorous acid, hypophosphorous acid salts, hypophosphorous acid esters, phosphate residue-containing organometallic salts, phosphite residue-containing organometallic salts, hypophosphite residue-containing organometallic salts, phosphate residue-containing coupling agents, phosphite residue-containing coupling agents, or hypophosphite residue-containing organometallic coupling agents.

Specific examples of phosphoric acid, phosphoric acid salts and phosphoric acid esters include phosphoric acid, ammonium phosphate, ammonium hydrogenphosphate, sodium hydrogenphosphate, potassium phosphate, sodium phosphate and dimethyl hydrogenphosphate. Specific examples of phosphorous acid, phosphorous acid salts and phosphorous acid esters are phosphorous acid, ammonium phosphite, potassium phosphite, sodium phosphite and diethyl phosphite. In addition, specific examples of hypophosphorous acid, hypophosphorous acid salts and hypophosphorous acid esters are hypophosphorous acid, potassium hypophosphite, calcium hypophosphite, sodium hypophosphite and magnesium dibutyl hypophosphite.

Specific examples of phosphate residue-containing organometallic salts, phosphite residue-containing organometallic salts, hypophosphite residue-containing organometallic salts, phosphate residue-containing coupling agents, phosphite residue-containing coupling agents, or hypophosphite residue-containing coupling agents include phosphate residue-containing titanate coupling agents, phosphite residue-containing titanate coupling agents, hypophosphite residue-containing titanate coupling agents, such as isopropyl-tris (dioctyl pyrophosphate) titanate, tetraisopropyl-bis (dioctyl phosphite) titanate, tetraoctyl-bis (di-tridecyl phosphite) titanate, tetra-(2,2-diallyloxymethyl-1-butyl) bis (di-tridecyl) phosphite titanate, bis (dioctyl pyrophosphate) oxyacetate titanate and bis (dioctyl pyrophosphate) ethylene titanate.

In the surface-modified nickel fine powder of the present invention, if the surface of the fine powder is modified with a coupling agent, in particular, a phosphate residue-containing titanate coupling agent, a phosphite residue-containing titanate coupling agent or a hypophosphite residue-containing titanate coupling agent, the coupling agent is preferentially and firmly adhered to the metal nickel fine powder as a monolayer through the hydrophilic groups of the coupling agent. For this reason, the coupling agent shows a sufficiently high effect in an amount smaller than that required when the paste comprises metal nickel fine powder together with a phosphate, phosphite or hypophosphite compound. Moreover, such surface-modified nickel fine powder of the present invention hardly causes any separation of the coupling agent even if the fine powder is subjected to a treatment such as pulverization.

If the surface-modified nickel fine powder of the present invention is used in a paste for forming an internal electrode of a multi-layered ceramic capacitor, the average particle size of the metal nickel fine particles is preferably not more than 5 μm and more preferably not more than 1 μm.

In the surface-modified nickel fine powder of the present invention, the phosphate, phosphite or hypophosphite compound is adhered to the surface of the metal nickel fine powder in an amount preferably ranging from 0.01 to 1% by weight and more preferably 0.03 to 0.7% by weight, as expressed in terms of that converted into the amount of phosphorus atom on the basis of the weight of the metal nickel (in other words, the total amount of the phosphorus atoms present in the phosphate, phosphite or hypophosphite compound is divided by the weight of the metal nickel fine powder and the quotient is multiplied by 100). This is because if the amount of the compound adhered to the surface is less than 0.01% by weight, the effect due to the adhesion is liable to be insufficient, while if the amount exceeds 1% by weight and such surface-modified nickel fine powder is used as an internal electrode material for multi-layered ceramic capacitors, the compound may sometimes adversely affect the dielectric characteristics of the resulting capacitor.

When preparing the surface-modified nickel fine powder of the present invention, or when a phosphate, phosphite or hypophosphite compound is adhered to the surface of the metal nickel fine powder, the metal nickel fine powder is immersed in a solution containing the phosphate, phosphite or hypophosphite compound dissolved therein to thus have the surface of the fine powder fully adapted to the solution, then the excess solution is removed by, for instance, filtration under reduced pressure and the immersed fine powder is dried. The solvent used for forming such a solution may be any one inasmuch as they can dissolve the phosphate, phosphate or hypophosphite compound and specific examples thereof are water, ethanol and methanol.

The present invention will hereunder be described in more detail with reference to the following Examples and Comparative Examples, but the present invention is not restricted to these specific Examples at all.

### EXAMPLE 1

To one liter of water, there was dispersed 20 g of metal nickel fine powder (Feret's diameter: 0.6 μm) to give a dispersion. Separately, a 0.5 mole/l phosphoric acid solution was prepared. To the dispersion, there was dropwise added 40 g (3% by weight as expressed in terms of the reduced amount of phosphorus atoms, on the basis of the total weight of the metal nickel) of the phosphoric acid solution while sufficiently stirring the dispersion and then the resulting mixture was stirred for additional one hour. The dispersion thus treated was filtered under reduced pressure to remove the excess of the phosphoric acid solution. The nickel fine powder recovered by the filtration under reduced pressure was dried at 70° C. to give nickel fine powder whose surface had been modified with phosphoric acid. The resulting nickel fine powder was inspected for the reduced amount of phosphorus atoms (i.e., the amount of the phosphoric acid) supported on the surface of the fine powder and as a result, it was found to be 0.05% by weight on the basis of the total weight of the metal nickel.

A pressure of 1 t/cm² was applied onto the surface-modified nickel fine powder (0.5 g) to thus form the fine powder into a pellet having a diameter of 5 mm and a height of about 6 mm. The pellet was inspected for the rate of heat shrinkage in a nitrogen gas atmosphere and at a rate of heating of 10° C./min using an apparatus for thermomechanical analysis (TMA/SS6000 available from Seiko Instruments Inc.). The results thus obtained are summarized in the following Table 1. In this respect, the rate of heat shrinkage is evaluated using the value observed prior to heating as the standard.

### EXAMPLE 2

The same metal nickel fine powder used in Example 1 (20 g) was dispersed in one liter of water to give a dispersion. Separately, 3.2 g of sodium dihydrogenphosphate dihydrate was dissolved in 40 ml of water to thus prepare a sodium dihydrogenphosphate solution. To the dispersion, there was dropwise added the sodium dihydrogenphosphate solution while the dispersion was sufficiently stirred and then the resulting mixture was stirred for additional one hour. The dispersion thus treated was filtered under reduced pressure to thus remove the excess sodium dihydrogen-phosphate solution. The nickel fine powder recovered by the filtration was dried at a temperature of 70° C. to give nickel fine powder whose surface had been modified with sodium dihydrogenphosphate. The resulting nickel fine powder was inspected for the amount of the sodium dihydrogenphosphate as expressed in terms of the reduced amount of phosphorus atoms supported on the surface of the fine powder and as a result, it was found to be 0.11% by weight on the basis of the total weight of the metal nickel.

A pellet was prepared by repeating the same procedures used in Example 1 using 0.5 g of the resulting surface-modified nickel fine powder. The pellet was used for inspecting the rate of heat shrinkage of the surface-modified nickel fine powder by repeating the same procedures used in Example 1. The results thus obtained are listed in the following Table 1.

### EXAMPLE 3

The same metal nickel fine powder used in Example 1 (20 g) was dispersed in one liter of acetone to prepare a dispersion. To the resulting dispersion, there was dropwise added 0.14 g of bis (dioctyl pyrophosphate) ethylene titanate (Plane Act KR-238S available from Ajinomoto Co., Ltd.), while sufficiently stirring the dispersion and then the resulting mixture was stirred for additional one hour. This dispersion thus treated was filtered under reduced pressure to thus remove the excess bis (dioctyl pyrophosphate) ethylene titanate. The nickel fine powder recovered by the filtration under reduced pressure was dried at a temperature of 70° C. to thus obtain nickel fine powder whose surface had been modified with bis (dioctyl pyrophosphate) ethylene titanate. The nickel fine powder was inspected for the amount of the bis (dioctyl pyrophosphate) ethylene titanate supported on the fine powder as expressed in terms of the reduced amount of phosphorus atoms on the basis of the total weight of the metal nickel and as a result, it was found to be 0.02% by weight.

A pellet was prepared by repeating the same procedures used in Example 1 using 0.5 g of the resulting surface-modified nickel fine powder. The pellet was used for inspecting the rate of heat shrinkage of the surface-modified nickel fine powder by repeating the same procedures used in Example 1. The results thus obtained are listed in the following Table 1.

### Comparative Example

The same metal nickel fine powder used in Example 1 was dispersed in one liter of water to give a dispersion. The dispersion was filtered under reduced pressure and then washed with acetone. The nickel fine powder obtained after the washing was dried at 70° C. A pellet was prepared by repeating the same procedures used in Example 1 using 0.5 g of the untreated nickel fine powder. The pellet was used for inspecting the rate of heat shrinkage thereof by repeating the same procedures used in Example 1. The results thus obtained are listed in the following Table 1.

TABLE 1

| | Rate of Heat Shrinkage (%) | | | |
|---|---|---|---|---|
| | 500° C. | 700° C. | 700° C. | 1100° C. |
| Example 1 | −0.8 | 0 | −2.5 | −7.2 |
| Example 2 | −1.3 | −0.5 | −2.3 | −8.0 |
| Example 3 | 0 | 0 | −1.8 | −5.7 |
| Comparative Example | −0.5 | −2.5 | −9.8 | −14.5 |

As will be seen from the data listed in the foregoing Table 1, the surface-modified nickel fine powder prepared in Examples 1 to 3 and according to the present invention show considerably low rates of heat shrinkage at high temperatures as compared with the untreated nickel fine powder prepared in Comparative Example.

As has been described above in detail, the surface-modified nickel fine powder according to the present invention has a sharp heat shrinkage-initiating temperature shifted to not less than 900° C., can thus be quite suitable for use in the manufacture of an internal electrode for multi-layered capacitors and can accordingly inhibit any generation of delamination and crack-formation during the production of a high capacitance multi-layered ceramic capacitor.

What is claimed is:

1. An internal electrode of a multilayer ceramic capacitor prepared by using a conductive paste comprising surface-modified nickel fine powder having an average particle size of not more than 5 μm, and in which the surface of metal nickel fine particles is modified with a phosphate compound, a phosphite compound or a hypophosphite compound.

2. The internal electrode of a multilayer ceramic capacitor prepared by using a conductive paste as set forth in claim 1, wherein the phosphate, phosphite or hypophosphite compound is phosphoric acid, a phosphoric acid salt, a phosphoric acid ester, phosphorous acid, a phosphorous acid salt, a phosphorous acid ester, hypophosphorous acid, a hypophosphorous acid salt, a hypophosphorous acid ester, a phosphate residue-containing organometallic salt, a phosphite residue-containing organometallic salt, a hypophosphite residue-containing organometallic salt, a phosphate residue-containing coupling agent, a phosphite residue-containing coupling agent or a hypophosphite residue-containing coupling agent.

3. The internal electrode of a multilayer ceramic capacitor prepared by using a conductive paste as set forth in claim 2, wherein the phosphate compound, the phosphite compound or the hypophosphite compound is a phosphate residue-containing titanate coupling agent, a phosphite residue-containing titanate coupling agent or a hypophosphite residue-containing titanate coupling agent.

4. The internal electrode of a multilayer ceramic capacitor prepared by using a conductive paste as set forth in claim 1, wherein the average particle size of the metal nickel fine particles is not more than 1 μm.

5. The internal electrode of a multilayer ceramic capacitor prepared by using a conductive paste as set forth in claim 2, wherein the average particle size of the metal nickel fine particles is not more than 1 μm.

6. The internal electrode of a multilayer ceramic capacitor prepared by using a conductive paste as set forth in claim 3, wherein the average particle size of the metal nickel fine particles is not more than 1 μm.

7. The internal electrode of a multilayer ceramic capacitor prepared by using a conductive paste as set forth in claim 1, wherein the phosphate, phosphite or hypophosphite compound is adhered to the surface of the metal nickel fine particles in an amount ranging from 0.01 to 1% by weight as expressed in terms of the reduced amount of phosphorous atoms, on the basis of the total weight of the metal nickel.

8. The internal electrode of a multilayer ceramic capacitor prepared by using a conductive paste as set forth in claim 2, wherein the phosphate, phosphite or hypophosphite compound is adhered to the surface of the metal nickel fine particles in an amount ranging from 0.01 to 1% by weight as expressed in terms of the reduced amount of phosphorous atoms, on the basis of the total weight of the metal nickel.

9. The internal electrode of a multilayer ceramic capacitor prepared by using a conductive paste as set forth in claim 3, wherein the phosphate, phosphite or hypophosphite compound is adhered to the surface of the metal nickel fine particles in an amount ranging from 0.01 to 1% by weight as expressed in terms of the reduced amount of phosphorous atoms, on the basis of the total weight of the metal nickel.

10. The internal electrode of a multilayer ceramic capacitor prepared by using a conductive paste as set forth in claim 4, wherein the phosphate, phosphite or hypophosphite compound is adhered to the surface of the metal nickel fine particles in an amount ranging from 0.01 to 1% by weight as expressed in terms of the reduced amount of phosphorous atoms, on the basis of the total weight of the metal nickel.

11. The internal electrode of a multilayer ceramic capacitor prepared by using a conductive paste as set forth in claim 5, wherein the phosphate, phosphite or hypophosphite compound is adhered to the surface of the metal nickel fine particles in an amount ranging from 0.01 to 1% by weight as expressed in terms of the reduced amount of phosphorous atoms, on the basis of the total weight of the metal nickel.

12. The internal electrode of a multilayer ceramic capacitor prepared by using a conductive paste as set forth in claim 6, wherein the phosphate, phosphite or hypophosphite compound is adhered to the surface of the metal nickel fine particles in an amount ranging from 0.01 to 1% by weight as expressed in terms of the reduced amount of phosphorous atoms, on the basis of the total weight of the metal nickel.
